(19) United States
(12) Patent Application Publication
(10) Pub. No.: US 2026/0212397 A1
(43) Pub. Date: Jul. 23, 2026

(54) Embedding Large Language Model (LLM) Based, Personalized Trivia Quizzes in a Chat Interface

(71) Applicant: eBay Inc., San Jose, CA (US)

(72) Inventors: Zhen Guo, Alpharetta, GA (US); Luchao Jin, Houston, TX (US); HEE JIN LEE, Austin, TX (US); Morteza Moazami Goudarzi, Cambridge, MA (US)

(73) Assignee: eBay Inc., San Jose, CA (US)

(21) Appl. No.: 19/028,623

(22) Filed: Jan. 17, 2025

(51) Int. Cl. G06Q 30/0601

(52) U.S. Cl. CPC G06Q 30/0631; G06Q 30/0641

(57) ABSTRACT

A large language model (LLM) based personalized chat quiz is described. In one or more implementations, information associated with an online marketplace is clustered into a plurality of topics. A plurality of prompts is generated, each prompt causing the LLM to generate a trivia quiz about a respective topic of the plurality of topics. Each prompt is generated by embedding a natural language description of the respective topic into a predefined prompt template. The prompts are input to the LLM, and generated trivia quizzes are received from the LLM. An indication of a customer service wait time is received. A generated trivia quiz about a personalized topic for the user based on tracked information about the user is selected from the generated trivia quizzes. The generated trivia quiz is embedded into the chat interface for presentation during the customer service wait time.

### BACKGROUND

Obtaining and retaining satisfied customers or users can be a challenge for any organization. One type of interface that many organizations use to service customers, at any of a variety of points throughout their customer lifecycle, is the chat messaging interface. Much current chat functionality in the online environment occurs between users at client devices and “virtual assistants” or “virtual agents” interacting with those users on behalf of an organization. These virtual agents and assistants provide computer-generated chat responses that often regurgitate generic answers to questions that are common to many customers or users.

For challenging and difficult problems, though, interaction with a human agent can often be the best manner of obtaining a resolution for a customer or user. Because the number of human agents that an organization employs is often limited, those agents regularly experience queues of customers or users waiting to chat with them that are several customers or users long. As a result, customers or users are forced to wait for some period of time before they are connected with a human agent in the chat interface.

### SUMMARY

Large language model (LLM) personalized chat quiz generation techniques for a waiting user are described. In one or more implementations, information associated with an online marketplace is clustered into a plurality of topics using at least one clustering algorithm. A plurality of prompts are generated, each prompt being configured to cause an LLM to generate a trivia quiz about a respective topic of the plurality of topics when provided as input to the LLM.

Each prompt is generated by embedding a natural language description of the respective topic into a predefined prompt template configured to elicit trivia quiz generation from the LLM. The plurality of prompts are input to the LLM, and a plurality of generated trivia quizzes are received from the LLM.

An indication of a customer service wait time for a user interacting with a chat interface of the online marketplace is received. A generated trivia quiz, from the plurality of generated trivia quizzes, about a personalized topic for the user, based on tracked information about the user, is selected. The generated trivia quiz is embedded into the chat interface for presentation during the customer service wait time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment, in an example implementation, that is operable to employ LLM-based personalized chat quiz generation techniques to embed a personalized chat quiz in a chat messaging interface.

FIG. 2 is an illustration of an LLM-based chat quiz generation system.

FIG. 3(a) is an illustration of a screenshot of a chat messaging interface provided via a display of a mobile device where a user begins a chat with a virtual chat assistant of an online marketplace.

FIG. 3(b) is an illustration of a screenshot of a chat messaging interface provided via a display of a mobile device where a personalized trivia quiz is included in a chat session with a virtual assistant of the online marketplace.

FIG. 3(c) is an illustration of a screenshot of a chat messaging interface provided via a display of a mobile device where a chat with a virtual chat assistant of the online marketplace continues.

FIG. 3(d) is an illustration of another screenshot of a chat messaging interface provided via a display of a mobile device where a chat with a virtual chat assistant of the online marketplace continues.

FIG. 3(e) is an illustration of another screenshot of a chat messaging interface provided via a display of a mobile device where a chat with a live human agent of the online marketplace occurs.

FIG. 4 is an illustration of a procedure in an example implementation of an LLM-based personalized chat quiz generation for a waiting user.

FIG. 5 illustrates an example of a system generally that includes an example of a computing device that is representative of one or more computing systems and/or devices that may implement the various techniques described herein.

### DETAILED DESCRIPTION

### Overview

Many who have sought customer service with a live human agent in an online environment are aware of the frustration involved in waiting for the live human agent to be connected to the chat while interacting with a virtual chat agent or chat “bot.” Conventional virtual chat agents may provide generic answers to questions, and may provide brief statements indicating that a human agent will enter the chat shortly. This is because oftentimes those virtual chat agents are unable to help users resolve their issues via a chat messaging interface, forcing the virtual chat agent to relinquish control of the interaction to a human agent. The wait time for this handover can in some instances be short, e.g., less than a minute. Oftentimes, however, the wait time can extend significantly longer, e.g., several minutes. If a user waits an extended period to chat with a human agent, the user may occupy himself or herself with other activities, such as using other applications (apps), web browsing, and so on.

For instance, a user waiting for the human agent can navigate away from a page or interface via which the chat messaging interaction is taking place. This can result in a host of problems, such as the user missing when the human agent is finally connected to the chat (e.g., because the user is viewing a different interface), the underlying code of the chat interface no longer allowing the chat to continue thereby preventing the connection with the human agent (e.g., because the context of the user interacting with the chat interface is not maintained), and the user, through interaction with interfaces of other applications or pages, causing termination (e.g., closing) of the chat messaging interface, to name just a few.

To address these problems, in one or more implementations, a personalized chat quiz is generated and presented via a chat interface to a user while the system attempts to connect the user with a human agent in the chat. The personalization of the chat quiz is based on stored user information that tracks the user's interaction with an online marketplace or merchant associated with the chat interface. Generation of the personalized chat quiz is technically achieved using one or more large language models (LLMs).

In at least one implementation, chat quizzes are pre-generated and then matched to the user in real time during the chat based on information about the waiting user. By way of example, in one or more implementations, the system clusters online marketplace information (e.g., online listings of items for sale) using one or more clustering techniques, so as to cluster the online marketplace information according to topics. Based on the topics identified with the clustering and by using at least one prompt template, the system forms natural language prompts that are then provided to one or more large language models (LLMs) to elicit the one or more LLMs to pre-generate chat quizzes based on the prompts. The repository of pre-generated chat quizzes can then be filtered for a waiting user based on the user's interests (or other information) which are determined by processing the stored information, including, for example, the user's purchase history.

Matching techniques can be employed to match information representing a quiz (e.g., a plurality of vectors representing the plurality of quizzes) to information representing a user (e.g., a vector representing the user), enabling the system to identify the quizzes that are better matches for the user (e.g., and at the particular time of the chat session) than others. For example, the one or more matching techniques may be executed to identify a quiz that best matches the user at the time the user waits to be connected to a human agent, where, for the best match, a vector representing the quiz is identified as being most similar (or shortest distance) to a vector representing the user. In one or more scenarios, a resulting best-matched quiz is then output via the chat interface during a virtual chat, and specifically while the system attempts to connect the live agent to the ongoing chat with the user.

Alternatively, or in addition, the system is capable of generating an individual quiz for a user in real time, while the system attempts to connect the user with a human agent in the chat messaging interface. Rather than matching the user with a pre-generated quiz using a matching or similarity technique, in such scenarios, the system may use information about the user interacting with the chat interface along with a prompt template to generate a prompt which elicits an LLM to generate a quiz in real time, i.e., during the chat session. In contrast to the pre-generated quiz scenario, in one or more such variations, the system instead generates the personalized quizzes while waiting to connect the user to the human agent. As with the pre-generated and matched quizzes, the system embeds the real-time LLM-generated quiz into the chat messaging interface for presentation to the user while the system attempts to connect a human agent to the chat session.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

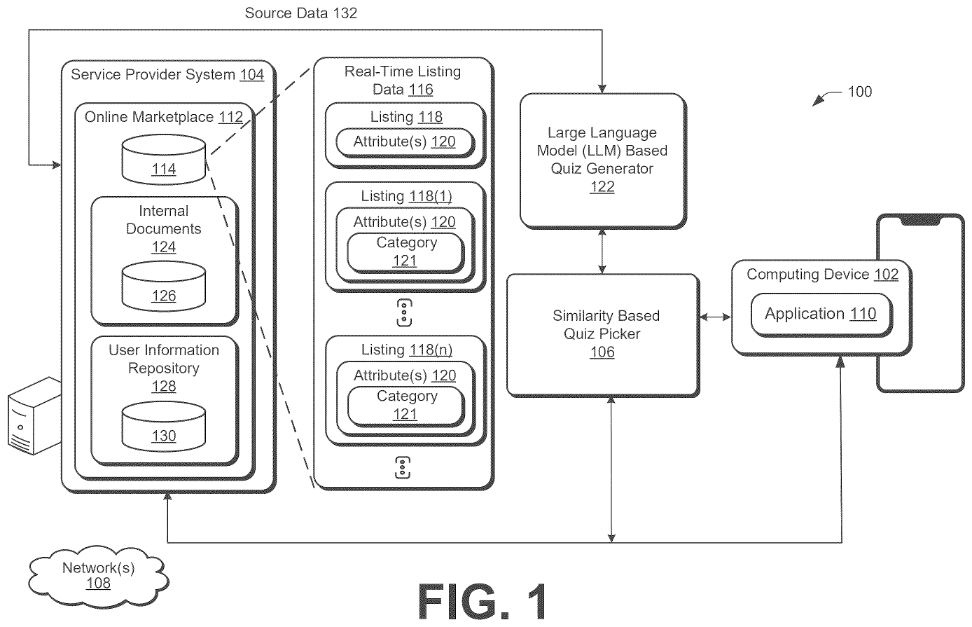

FIG. 1 is an illustration of an environment 100, in an example implementation, that is operable to employ LLM-based personalized chat quiz generation techniques to embed a personalized chat quiz in a chat messaging interface. The environment 100 includes a computing device 102, a service provider system 104, an LLM-based quiz generator 122, and a similarity-based quiz picker 106, which may operate as a machine learning model (MLM) and/or a controller. In one or more implementations, the computing device 102, the service provider system 104, the LLM-based quiz generator 122, and the similarity-based quiz picker 106 are communicatively coupled, one to another, via network(s) 108. One example of the network(s) 108 is the Internet, although one or more of the computing device 102, the service provider system 104, the LLM-based quiz generator 122, and the similarity-based quiz picker 106 may be communicatively coupled using one or more different connections or different networks in various implementations.

Although the LLM-based quiz generator 122 and the similarity-based quiz picker 106 are depicted in the environment 100 as being separate from the other and from the service provider system 104, in one or more implementations, an entirety or various portions of the LLM-based quiz generator 122 and the similarity-based quiz picker 106 are implemented as a single entity, and/or implemented at or by the service provider system 104. In at least one implementation, for example, at least a portion of the similarity-based quiz picker 106 and the LLM-based quiz generator 122 are implemented using various resources of the service provider system 104, such as hardware resources, server-based storage, an operating system, firmware, processors, and so forth. Alternatively or additionally, at least a portion of the LLM-based quiz generator 122 and the similarity-based quiz picker 106 are implemented using a third-party service, such as a web services platform that provides one or more hardware and/or other computing resources to support providing of services by web service providers.

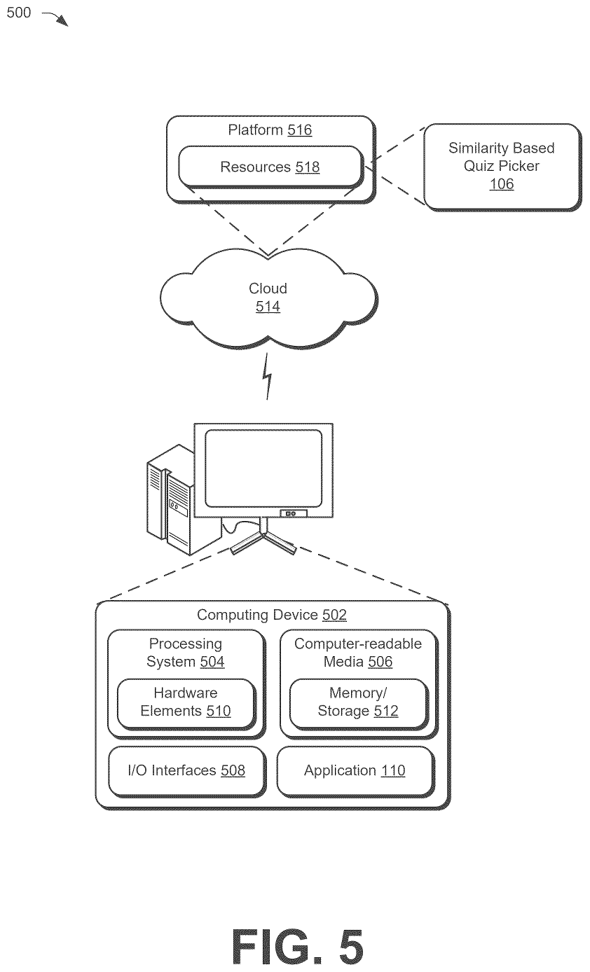

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full-resource devices with substantial memory and processor resources to low-resource devices with limited memory and/or processing resources. Additionally, although in instances in the following discussion, reference is made to a computing device in the singular, a computing device is also representative of a plurality of different devices, such as multiple servers of a server farm or data center utilized to perform operations “over the cloud” as further described in relation to FIG. 5.

In at least one implementation, the application 110 of the computing device 102 supports communication of data across the network(s) 108, such as between the computing device 102 and the service provider system 104 and/or between the computing device 102 and the similarity-based quiz picker 106. By supporting such data communication, the application 110 provides a respective user of the computing device 102 (and users of other computing devices) access to an online marketplace 112.

For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website.

Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. After registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 118 for items and to expose those listings 118 (e.g., publish them) across the network(s) 108 to one or more user computing devices 102. For example, the online marketplace 112 may generate listings 118 of items for sale and expose those listings 118 to computing devices 102, such that users of the computing devices 102 can interact with the listings 118 via user interfaces to initiate transactions (e.g., purchases, add to wish lists, share, and so on) in relation to the respective item or items of the listings 118. In accordance with the described techniques, the online marketplace 112 is configured to generate listings 118 for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain-backed assets (e.g., non-fungible tokens (NFTs)), to name just a few.

In the illustrated environment 100, the online marketplace 112 includes a storage device 114, which is depicted as maintaining real-time listing data 116. The real-time listing data 116 includes the listings 118 of the online marketplace 112. Examples of such listings include listing 118(1) and listing 118(n), where ‘n’ represents any integer number greater than or equal to 2. The real-time listing data 116 is depicted with ellipses to indicate the existence of more listings than the initial listing 118, the listing 118(1), and the listing 118(n).

The contents of each listing 118 may include a variety of information about the listing and/or item being listed, such as an item name, a listing description, a listing category, price information, brand name, shipping options, and other related data. As discussed further below, the contents of each listing 118 may be used in training the LLM-based quiz generator 122. Also as discussed further below, the data that comprises the contents of each listing 118 can be partitioned into attributes 120 that are discreet data points used in training.

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices.

The service provider system 104 may implement the online marketplace 112 by using servers that execute stored instructions to deploy various services of the service provider system 104, such that those services perform numerous computations that are effective in providing the functionality described above and below. It is to be appreciated that the online marketplace 112 may include more, fewer, or different components without departing from the spirit or scope described herein.

In one or more implementations, the online marketplace 112 is accessible by decentralized computing devices (including the computing device 102) that correspond to “clients” of the online marketplace 112, e.g., users that have accounts with the online marketplace 112 and/or that access the online marketplace as a “guest” that is not signed into such an account or tracked as a user with an account.

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform desired functionality, such as to interact with chat messaging interfaces to access support and/or customer service agents of the online marketplace 112 through chat sessions with those agents. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to purchase one or more items from the listings of the online marketplace 112.

A user that is a seller, for instance, may interact with one or more user interfaces of the online marketplace 112 (e.g., output via the application 110) to provide information about one or more items that the user is causing to be listed on the online marketplace 112. Such user interfaces may include prompts that instruct, or guide, users that are sellers to provide various information about items being listed. Examples of information that such interfaces prompt sellers for and that those users provide include but are not limited to a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information may be referred to herein as “attributes” of the listing (e.g., attribute(s) 120). For example, a title of the listing may be an attribute of the listing, a description of the item being listed may be an attribute of the listing, one or more images uploaded or selected for the listing may be one or more attributes of the listing, color(s) of the item may be an attribute of the listing, a category of the item may be an attribute of the listing, and so forth.

In one or more implementations, the online marketplace 112 saves and maintains the input information for a listing in the storage device 114 in fields of a data structure or data record populated for the listing, where a given field and the information populated and maintained for the given field correspond to a particular attribute of the listing. For instance, a ‘title’ field of such a data structure or data record may be populated with information (e.g., text) input into a user interface by a seller of a listing. The title field and the information input by the user as the title of the listing correspond to an attribute of the listing, e.g., a title attribute. In one or more implementations, one or more of the attributes of a listing may be derived and then populated by the online marketplace 112, such as by the online marketplace 112 processing one or more portions of the information input by a user to populate one or more respective attributes of the listing.

As indicated above, there is a significant amount of data that may be transmitted over the network(s) 108 between the computing device 102 and the online marketplace 112 and that is maintained within the service provider system 104. As indicated above, a user of the computing device 102 may interact with the online marketplace 112 over multiple transactions either as a buyer, a seller, and/or as a prospective buyer of (i.e., “watching”) one or more listings 118.

In at least one example, a user (whether buyer or seller) of the computing device 102 may have a question or issue regarding some aspect of its interactions with the service provider system 104, and particularly the online marketplace 112 for which the user would like to contact customer service. As indicated above, the user of the computing device 102 may select to contact a live human customer service agent (e.g., via a chat messaging interface) to have his or her questions or other issues resolved (e.g., during a chat session).

The application 110 thus may include a chat function that facilitates a user of the computing device 102 to communicate with virtual and human agents that are representatives of the service provider system 104 and the online marketplace 112, e.g., during a chat messaging session. As noted above, chat sessions with customer service agents can be frustrating to users because transitioning from chatting with a virtual chat bot to chatting with a live human agent can be monotonous and/or involve waiting for an undesirable amount of time.

In accordance with the described techniques, the online marketplace 112 generates and presents personalized quizzes to users via chat messaging interfaces during wait periods of chat sessions, such as while the online marketplace 112 attempts to connect a human agent to a chat session to exchange messages with a user. As discussed above and below, the online marketplace 112 may leverage clustering techniques, LLMs, and one or more matching (similarity) algorithms to generate a plurality of quizzes which relate to information about or on the online marketplace 112.

During a wait period of a chat session, the online marketplace 112 may select at least one of these already-generated quizzes that is relevant to the user waiting in the chat session and embed the selected quiz in the chat messaging user interface. Within the chat interface, the user can interact with the quiz, such as by answering questions of the quiz. Instead of waiting idly or breaking context with the chat interface, presenting the quiz can engage the user to continue providing user input via the chat messaging interface, which further causes the user's navigation and input to remain in the context of the chat messaging interface (e.g., rather than navigating elsewhere).

In one or more implementations a specific quiz(s) is provided to a chat messaging interface of the computing device 102. The similarity-based quiz picker 106 may include or function as an LLM or a controller to determine the specific quiz to present to the user via the chat messaging interface. As discussed in more detail below, the similarity-based quiz picker 106 may do so using matching and selection techniques to select a specific quiz from a plurality of quizzes pre-generated by the LLM-based quiz generator 122 in response to LLM prompts. The similarity-based quiz picker 106 may also provide a prompt directly to the LLM-based quiz generator 122 to enable the LLM-based quiz generator 122 to generate in real time, as the user is waiting in a chat session, a single quiz to be embedded in a chat messaging interface of the computing device 102.

Succinctly put, in one or more implementations, quizzes may be pre-generated by the LLM-based quiz generator 122 in response to LLM prompts, and a single quiz may be selected by the similarity-based quiz picker 106 based on a closest match between a vector representative of user information obtained from the computing device 102 and several vectors representative of the pre-generated quizzes obtained from the LLM-based quiz generator 122.

Source data 132, which serves as a knowledge base of the LLM-based quiz generator 122 in generating quizzes, may be provided by the service provider system 104 to the LLM-based quiz generator 122. Broadly, the source data 132 is a corpus of documents and/or other information (e.g., listings of the online marketplace) from which LLMs can access information to generate quizzes. Alternatively or additionally, the source data 132 is used as a corpus of such documents and/or other information for the purpose of fine tuning LLMs, such as LLMs that have already been generically trained on large datasets, an example of which is the “Pile,” and are finely tuned for the online marketplace 112 using one or more training techniques for fine-tuning LLMs. In any case, in one or more implementations, the service provider system 104 stores the real-time listing data 116 and the internal documents 124 comprising the source data 132 used by the LLM-based quiz generator 122 in pre-generating quizzes.

Stated another way, in one or more implementations the source data 132 includes the real-time listing data 116 that comprises the listings 118 that are goods or services provided for sale in the online marketplace 112. Additionally, or alternatively, the source data 132 includes the internal documents 124, examples of which include information on an about us page, a website or web app map, frequently asked questions (FAQs) and answers, contact information, publication announcements, press releases, descriptions of a team (e.g., an executive team and/or employee bios) associated with the service provider system 104, career information, processes and procedures of the online marketplace 112, policy information, and/or other curated information related to the online marketplace, to name just a few. As discussed further below, in one or more implementations, the listings 118 and/or information from the internal documents 124 are clustered into topics that can each provide a basis for pre-generated quizzes. The LLM-based quiz generator 122 further becomes trained at least in part using the source data 132 that includes the listings 118 from the real-time listing data 116, such as multiple listings 118(1)-118(n), and the internal documents 124. In one or more implementations, the listings 118 in the source data 132 are already labeled with categories 121, which can further serve as a basis for clustering the real-time listing data 116 into topics. For instance, a topic identified through the clustering may correspond to one or more categories 121, such as a luxury handbag topic, vintage sneakers topic, video games topic, and/or trading cards topic, to name just a few.

In one or more implementations, the LLM-based quiz generator 122 generates quizzes related to the real-time listing data 116. That is to say, the specific quiz that is presented in a chat messaging interface of the computing device 102 often relates to listings 118 that may be of interest to the user of the computing device 102 as determined by the similarity-based quiz picker 106 based on previously stored shopping history, watch lists, current cart, and the like.

In one or more implementations, the LLM-based quiz generator 122 generates quizzes related to customer service procedures and policies of the online marketplace 112. For example, generated quizzes might relate to a return policy of the online marketplace 112 related to purchases made from the listings 118. Additionally, generated quizzes may relate to financing options for purchases made of products described by the listings 118. Further, generated quizzes may relate to logistics of the listings 118 such as, for example, how long and how often a listing 118 can be posted on a website of the online marketplace 112 before the listing 118 will be removed from the website. The above example quizzes are not an exhaustive list, and are exemplary only.

The data that relates to the customer services procedures and policies of the online marketplace 112 is stored in the service provider system 104 in a series of internal documents 124 that are stored in a storage device 126. In one or more implementations, the internal documents 124 are not limited to those documents related to customer service procedures and policies. Rather, the internal documents 124 may represent the retained written documents of the service provider system 104 and the online marketplace 112, a subset of which may be useful in the generation of quizzes by the LLM-based quiz generator 122.

In one or more implementations, the internal documents may include any of a variety of information related to the online marketplace, examples of which include frequently asked questions curated for the online marketplace 112, articles from a customer service repository associated with the online marketplace 112, or press releases published by the online marketplace 112. The above example internal documents are not an exhaustive list, and are exemplary only.

In one or more implementations, there is additional user data stored in the computing device 102 of each user (e.g., buyer, seller, watcher) who interacts with the service provider system 104 and the online marketplace 112. The computing device 102 may store user data including a past history of the user's interaction with the service provider system 104 and the online marketplace 112 as well as data related to a current interaction with the service provider system 104 and the online marketplace 112. For example, user data of the computing device 102 may include data such as a purchase history, an item watch list history, a current watch list, current shopping cart content, and other analogous data.

Alternatively, or in addition, user information is stored in the user information repository 128 of the service provider system 104. That is to say, the service provider system 104 maintains and stores the data about its users. In particular, user data of the users of the service provider system 104 and the online marketplace 112 are stored in storage device 130. The storage device 130 and the storage device 126 may be configured in an analogous manner as the storage device 114 discussed in detail above.

In one or more implementations, user data stored in the user information repository 128 is also provided to the similarity-based quiz picker 106. As is discussed in further detail below, user data may be included in a prompt provided from the similarity-based quiz picker 106 to the LLM-based quiz generator 122, resulting in a quiz that is generated by the LLM-based quiz generator 122 and embedded in a chat message interface in the computing device 102.

### Implementation Details

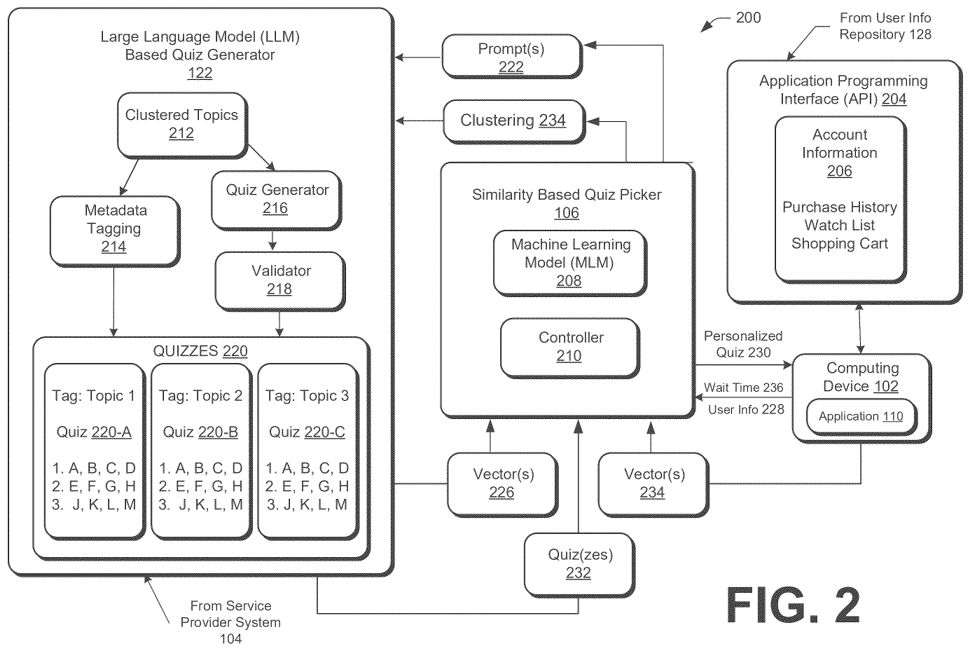

FIG. 2 is an illustration of an LLM-based chat quiz generation system 200. The chat quiz generation system 200 includes the computing device 102, the similarity-based quiz picker 106, and the LLM-based quiz generator 122.

In the chat quiz generation system 200, the LLM-based quiz generator 122 and the similarity-based quiz picker 106 cooperatively function together. FIG. 2 illustrates that an end result of the LLM-based chat quiz generation system 200 is the provision of a personalized quiz 230 to a chat messaging interface, such as via the application 110 of the computing device 102 while a user is waiting to interact with a human agent during a chat session.

In one or more implementations, the LLM-based quiz generator 122 is a processing device that executes a computational model designed for natural language processing tasks. The LLM-based quiz generator 122 has the ability to perform natural language processing tasks by learning statistical relationships from vast amounts of text during a self-supervised and/or a semi-supervised training process.

In one or more implementations, the LLM-based quiz generator 122 may be or include either an open-source LLM or a closed-source LLM. The LLM-based quiz generator 122 can be hosted on a third-party, cloud-based server, or can be a proprietary LLM of the service provider system 104 and the online marketplace 112, and hosted by the same at central servers, accessible over an enterprise network.

As discussed above, the knowledge base of the LLM-based quiz generator 122 is received from the service provider system 104 and the online marketplace 112. The knowledge base may include real-time listing data 116 and also data obtained from the internal documents 124. Although these sources of data are discussed herein, the LLM-based quiz generator 122 may leverage data from other sources to generate quizzes, such as publicly exposed data from competitor web pages, news data, and so on.

In one or more implementations, the computing device 102 connects with the user information repository 128 via an application programming interface (API) 204 to obtain and/or update user account information 206. In particular, and as indicated above, the user account information 206 may include a purchase history, an item watch history, shopping cart items, browsing and/or navigation data, application use data, and other analogous data. The above list of types of user account information is not exhaustive and is exemplary.

As is known in the art, and in contrast to a user interface, which connects a computer to a person, an API connects computers or pieces of software to each other. The API 204 is not intended to be used directly by an end user. In one or more implementations, the computing device 102 makes an API call for the API 204 to obtain up-to-date user account information 206 without seeking input from the user of the computing device 102.

In one or more implementations, the similarity-based quiz picker 106 includes or otherwise operates as at least one machine learning model (MLM) 208 in the LLM-based chat quiz generation system 200, when a selection of a particular quiz is made from a plurality of quizzes 220 that are pre-generated by the LLM-based quiz generator 122. In one or more implementations, the similarity-based quiz picker 106 operates as a controller 210 in the LLM-based chat quiz generation system 200 when requesting generation of a single quiz in real time.

The MLM 208, similar to an LLM, is a program that can find patterns or make decisions from a previously unseen dataset. For example, in natural language processing, machine learning models can parse and correctly recognize the intent behind previously unheard sentences or combinations of words.

Thus, in one or more implementations, the computing device 102 after receiving user account information 206 from the user information repository 128 further provides user information 228 to the similarity-based quiz picker 106. As discussed in more detail below, the similarity-based quiz picker 106 employs the user information 228 in multiple ways to obtain a personalized quiz 230 to provide via a chat messaging interface, such as in the application 110 of the computing device 102.

In one or more implementations, for example, the similarity-based quiz picker 106 may operate as a MLM 208 by providing a prompt 222 in natural language format, generated based on the user information 228, that further narrows the pre-generated plurality of quizzes 220 to a selected number of quizzes 232 that are relevant to topics extracted from the user information 228 as determined by the similarity-based quiz picker 106. The MLM 208 further matches a vector 234 based on the user information 228 with vectors based on one or more of the selected number of quizzes 232 provided by the LLM-based quiz generator 122 to the similarity-based quiz picker 106. For example, the similarity-based quiz picker 106 may execute one or more similarity algorithms (e.g., Euclidean distance, cosine similarity, etc.) to determine a similarity between a vector 234 representing the user information 228 and vectors represented the selected number of quizzes 232. The quiz presented to the user may be selected based on the determined similarity, e.g., the “most” similar, second “most” similar, or a different quiz if a “most” similar has already been presented to the user. Additionally or alternatively, the similarity-based quiz picker 106 may operate as a controller 210 in developing a specific prompt 222 based on the user information 228 to obtain in real-time a single quiz 220, in response to the specific prompt 222, from the LLM-based quiz generator 122.

As indicated above, in one or more implementations, the LLM-based quiz generator 122 generates a plurality of quizzes 220 prior to receiving the user information 228 from the computing device 102 in connection with a chat session during which a quiz is to be provided in a chat interface. In one or more implementations, voluminous real-time listing data 116 and/or information of the internal documents 124 is clustered 234 by the similarity-based quiz picker 106 as clustered topics 212, which can include clustered listings.

The similarity-based quiz picker 106 performs processing of the listings 118 and the internal documents 124 as described above and below, resulting in the clustered topics 212. For example, the similarity-based quiz picker 106 uses one or more clustering algorithms, such as k-means or any other clustering algorithm. Additionally or alternatively, clustering of the listings 118 may be performed in the LLM-based quiz generator 122.

The clustering performed by the similarity-based quiz picker 106 and/or the LLM-based quiz generator 122 on the listings 118 of the real-time listing data 116 may be based on an existing hierarchical taxonomy of the online marketplace 112. That is to say, the online marketplace 112 has an established topical hierarchy of all goods and services that are listed for sale, and the listings 118 may be clustered according to the same structure and/or further clustered while considering this taxonomy.

In one or more implementations, known clustering algorithms are the mechanisms used to obtain the clustered topics 212 (e.g., clustered listings). For example, a nearest neighbor algorithm may be used to cluster the real-time listing data 116 and/or the internal documents 124. As another example, the latent Dirichlet allocation (LDA) algorithm may cluster the real-time listing data 116 and/or the internal documents 124. As a third example, the K-means clustering algorithm may cluster the real-time listing data 116 and/or the internal documents 124. Other clustering algorithms include k-medoids, k-medians, Clustering Large Applications based on RANdomized Search (CLARANS), and balanced iterative reducing and clustering using hierarchies (BIRCH). The clustering algorithm examples mentioned above and below are not an exhaustive list and other algorithms now existing, or developed in the future, may be used to obtain the clustered topics 212.

In one or more implementations, the real-time listing data 116 that is stored as listings 118 and the internal documents 124 is thus sorted into clustered data as clustered topics 212 for the LLM-based quiz generator 122. Processing by the similarity-based quiz picker 106 or the LLM-based quiz generator 122 may further include providing metadata tags 214 on the clustered topics 212 (e.g., clustered listings and/or topics of internal documents).

More specifically, the clustered topics 212 may be tagged with metadata for easy retrieval by the similarity-based quiz picker 106 according to the metadata tags 214. The metadata tags 214 may include items such as category, price, brand name, country of origin, discounts offered, and the like to facilitate easy retrieval/access.

In one or more implementations, in addition to metadata tagging, the text of the listings 118 and/or the internal documents 124 may be extracted and provided to the LLM-based quiz generator 122. The extracted text of each listing 118 and/or each internal documents 124 can be stored in a manner that makes the listings 118 and information from the documents easily searchable and retrievable. Both the metadata tags 214 and the extracted text may utilize key-value pairs, which associate characteristics of the listings 118 with respective particular values, to facilitate easy retrieval.

In one or more implementations, the plurality of quizzes 220 are confirmed by a validator 218 as being substantially accurate. The validator 218 may sample quizzes generated by the quiz generator 216 and ensure accuracy of the quizzes. The functioning of the validator 218 can be performed by human validators or can additionally or alternatively be performed by an LLM that is trained to recognize errors in generated quizzes. If errors in the quizzes generated by the quiz generator 216 reach a threshold level, corrections in the metadata tagging or in the text extraction can be undertaken to correct the errors.

In FIG. 2, the plurality of generated and validated quizzes 220 are stored in a repository and are tagged with a topic. By way of example, Quiz 220-A is tagged with a first topic (e.g., Topic 1), the Quiz 220-B is tagged with a second topic (e.g., Topic 2), and the Quiz 220-C is tagged with a third topic (e.g., Topic 3). The three generated quizzes 220 illustrated in FIG. 2 are exemplary: the quiz generator 216 can generate multiple other quizzes (not shown) variously tagged with Topics 1, 2, and 3. Additionally, the quiz generator 216 can generate quizzes related to any of a variety of other topics in addition to Topics 1, 2, and 3.

In one or more implementations, the similarity-based quiz picker 106 utilizes the MLM 208 to generate prompts 222 (e.g., using identified topics and a predefined prompt template) that are in natural language format. The prompts 222 are generated for the topics by which the listings 118 are clustered. The natural language prompts 222 are configured to elicit the LLM-based quiz generator 122, using the quiz generator 216 (a large language model), to generate the plurality of quizzes 220. In scenarios where the plurality of quizzes 220 are pre-generated, the LLM-based quiz generator 122 provides to the similarity-based quiz picker 106 (and more specifically the MLM 208) a plurality of quizzes 232, which can be based on the user information 228.

To select a most relevant quiz from among the response quizzes 232 provided to the similarity-based quiz picker 106, the MLM 208 performs a process of similarity matching of the user information 228 with the plurality of quizzes 232. In one or more implementations, the MLM 208 performs this matching process by embedding the plurality of quizzes 232 in vectors 226 and further embeds the user information 228 in a vector 234. A comparison of the vectors 226 and the vector 234 is performed, using one or more similarity algorithms, to obtain a match (e.g., a best or closest match) of the user information 228 with one or more of the plurality of quizzes 232 provided to the similarity-based quiz picker 106 by the LLM-based quiz generator 122.

The vectors 226 representing the plurality of quizzes 232 may be compared to the vector 234 representing the user information 228 using any of a variety of known vector comparison algorithms, such as Euclidean distance, cosine similarity, and regression modeling, to name just a few. The MLM 208 can be trained to compare the vectors 226 representing the plurality of quizzes 232 to the vector 234 representing the user information 228. In one or more implementations, at least one MLM 208 includes one or more transformers, examples of which include but are not limited to the bidirectional encoder representations from transformers (BERT) and sentence BERT. Further, the at least one MLM 208 may be trained to match the plurality of quizzes to users using one or more training algorithms, including, for example, gradient descent for parameter selection throughout the training. In another implementation, the MLM 208 may be trained to match quizzes to users in a similar manner as a recommendation model that is used by the online marketplace 112 to recommend particular listings 118 to particular users.

In one or more implementations, the similarity-based quiz picker 106 selects the personalized quiz 230, for presentation in a chat interface displayed the computing device 102, that is the best match (as determined by the vector comparison discussed above) between the user information 228 and the plurality of quizzes 232. However, the similarity-based quiz picker 106 may alternatively determine, by ranking the results of the comparison of the vectors, that more than one of the plurality of quizzes 232 are relevant matches, e.g., a top-k quizzes and/or quizzes above a threshold similarity. A random selection among those matches, by the similarity-based quiz picker 106, may then determine the specific personalized quiz 230 as a match (e.g., a best match at the time) to present from the multiple relevant matches. The selected quiz from the multiple relevant matches is further selected for presentation in the chat interface displayed of the computing device 102.

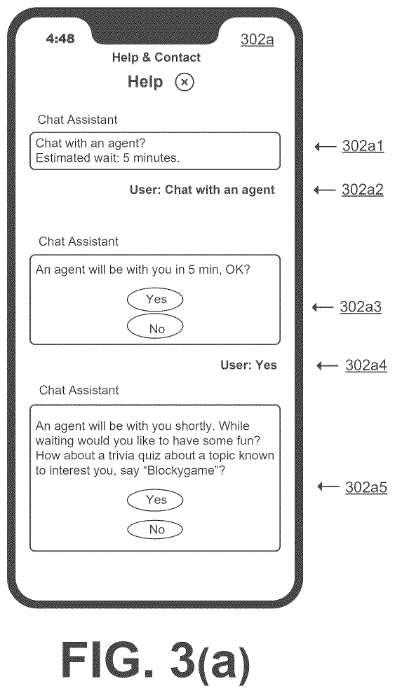

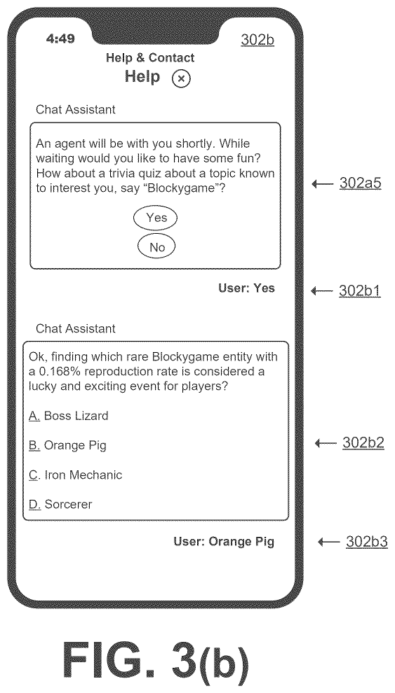

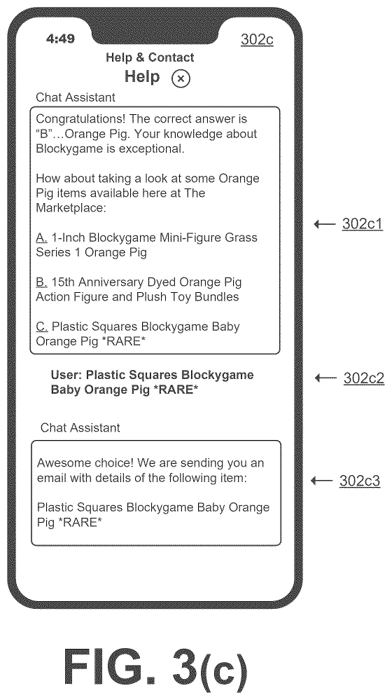

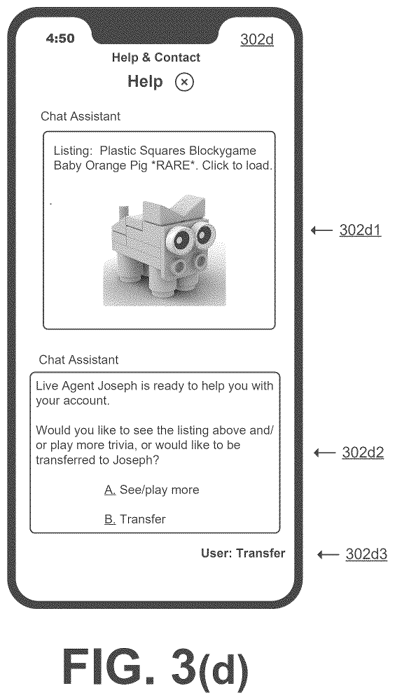

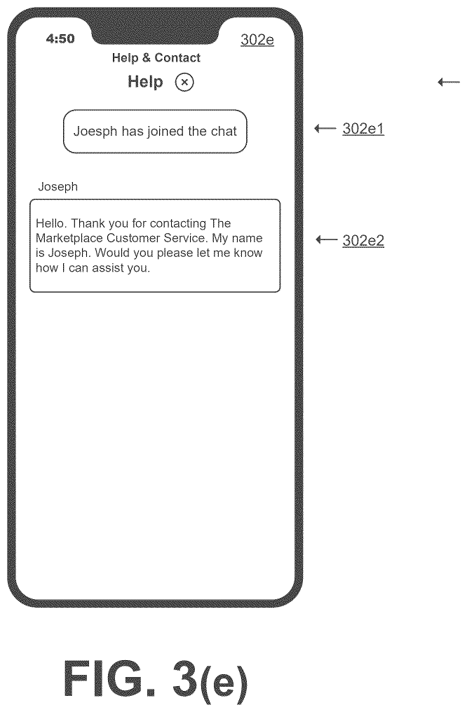

In one or more implementations, the application 110 provides to the similarity-based quiz picker 106 an indication of a wait time 236 in a chat session, such as an indication of how long a user of the computing device 102 will have to wait to chat with a human agent of the online marketplace 112 in a chat session facilitated by a chat messaging interface in the application 110. When the personalized quiz 230 is determined (based on the vector comparison of vectors 226 representative of the quizzes 232 and a vector representative of the user information 228) as a best match, the quiz 230 is presented, during the wait time 236, in a chat messaging interface, e.g., of the application 110. The chat function and the chat messaging interface of the application 110 is shown in more detail in FIG. 3(a) to 3(e), and is discussed further below.

The discussion above has primarily focused on the listings 118 of the online marketplace 112 as the source of material for the clustering of topics (to produce the clustered topics 212) and the pre-generation of the plurality of quizzes 220 by the quiz generator 216. However, the subject matter of the plurality of quizzes 220 is not so constrained. As indicated above, the internal documents 124 related to customer service procedures and policies may also be clustered 212, and based on generated natural language prompts 222 provided to the LLM-based quiz generator 122. In this way, a plurality of quizzes 220 based on topics identified from the internal documents 124 (through clustering) can be generated by the quiz generator 216. Processing the internal documents 124 to generate pre-generated quizzes 220 may be performed in a substantially analogous manner to the processing of the listings 118 discussed above.

Further, the discussion regarding the functionality of the LLM-based chat quiz generation system 200 has focused on pre-generation of quizzes 220 by the quiz generator 216 and subsequent matching of the generated quizzes 220 with the user information 228 (through the vectors 226 and the vector 234, respectively). By pre-generation it is meant that the quizzes are generated, for example, before the user, to which the quiz is matched and provided, is connected to the chat session facilitated by the chat interface and/or before it is determined that there will be a wait time before the system is able to connect a human agent to the chat session. However, in one or more implementations, and as indicated above, a single quiz 232 may be generated in real-time by the LLM-based quiz generator 122 as an LLM response to a specific natural language prompt 222 provided in a customized prompt template by the similarity-based quiz picker 106, e.g., when it operates as a controller 210. In such scenarios, the single quiz 232, rather than being generated beforehand, may be generated during the chat session, such as responsive to determining that there will be a wait time before the system is able to connect a human agent to the chat session. Such as by generating a prompt during a live chat session to elicit a quiz from an LLM and then present it via a chat interface facilitating the chat session. In at least one implementation, such a prompt is configured based on the user information and a predefined prompt template.

The fine-tuning of an LLM used to implement the LLM-based quiz generator 122 may be performed using techniques such as the masked-token training technique and/or the next-token training technique. Other examples of fine-tuning techniques include transfer learning, learning rate schedules, early stopping, data augmentation, and layer freezing. These examples are intended to be exemplary and are not an exhaustive list. To fine-tune an LLM, the service provider system 104 (or some other entity) may use a corpus of information associated with the online marketplace 112. In at least one implementation, this fine-tuning is performed after the model is initially trained generically on a large dataset, such as the “Pile,” and before the prompts 222 are provided as input to the LLM-based quiz generator 122 for generating quizzes; the prompt(s) 122 result in use of such a fine-tuned LLM. By way of example, sentences and phrases distilled from the knowledge base of the online marketplace 112 and/or information from the real-time listing data 116 are used to fine-tune an LLM of the LLM-based quiz generator 122. Alternatively, or additionally, this fine tuning includes training the LLM using the masked-token training technique and/or the next-token training technique on sentences derived from a corpus of information, such as a knowledge base (e.g., the internal documents 124, the user information repository 128, and/or the real-time listing data 116) associated with the online marketplace 112.

In at least one implementation where a single quiz 232 is generated in real time by the LLM-based quiz generator 122, the controller 210 may be configured to convert the user information 228 into a natural language prompt 222 and incorporate it into a specific prompt template. In one or more implementations, the purchase history of the user may be used as the basis of the natural language prompt. As an example, the controller 210 may produce a natural language prompt as follows:

“Can you generate some questions for a trivia game that is entertainment for a customer? You are provided with the historical purchases of the customer as below. First, infer topics and entities (such as person, item, event) that the customer is interested in based on the purchases. Then, generate a set of questions around the topics and entities. Make your questions as funny as possible. Purchase history: (i) Hott CD player portable; (ii) Fender professional series tweed instrument cable; (iii) Sicce syncra silent nano submersible pump.”

The above sample prompt 222, generated according to a specific prompt template accessible by the similarity-based quiz picker 106, may be provided to the LLM-based quiz generator 122. The trained LLM-based quiz generator 122 (e.g., the LLM) may receive the prompt and process the input prompt, causing the LLM to provide a sample quiz 232 as output. For example, the LLM-based quiz generator 122 may provide the following output (quiz) in response to the prompt 222 quoted above, as follows:

“Why did the guitar cable go to school? A) To get “plugged” into education; B) To learn how to “conduct: itself better; C) To avoid any “unshielded” behavior; and D) Can someone give me a “break”? Please select your best answer.”

Once the single quiz 232 is provided to the similarity-based quiz picker 106, the similarity-based quiz picker 106 may in turn provide the personalized quiz 230 to a chat messaging interface, such as in the application 110 of the computing device 102 during the wait time 236. A user of the computing device 102 can access the personalized quiz 230 through the chat messaging interface while waiting to chat with a human agent of the online marketplace 112.

FIG. 3(a) to 3(e) show screen shots of a chat messaging interface in the application 110 of the computing device 102 that display an LLM-based personalized chat quiz. The user of a computing device 102 may be waiting to chat with a human agent of the online marketplace 112, and in FIG. 3(a) to 3(e), the computing device 102 accessed by the user is a mobile device.

FIG. 3(a) depicts a screenshot 302a of a chat messaging interface provided in the display of a mobile device where a user begins a chat with a virtual chat assistant of the online marketplace 112. The screenshot 302a first shows a chatbox 302a1 where a virtual chat assistant inquires whether a user would like to chat with an agent. The virtual chat assistant further indicates that there is a 5-minute wait to chat with an agent. The user enters a response 302a2 that the user would like to “Chat with an agent.”

In the chatbox 302a3, the virtual chat assistant inquires whether a 5-minute wait to chat with a human agent is acceptable (e.g., OK) to the user. The user enters a response 302a 4 indicating that “Yes,” the 5-minute wait is acceptable. In the chatbox 302a5, the virtual chat assistant inquires whether the user would like to play a trivia quiz (e.g., about Blockygame, which is a game known to interest the user based on any of the user's shopping history, current cart, or current watch list).

FIG. 3(b) depicts a screenshot 302b of a chat messaging interface provided in the display of a mobile device where a personalized trivia quiz is included in a chat session with a virtual assistant of the online marketplace 112. The screenshot 302b first shows the chatbox 302a5 where the virtual agent inquires whether the user would like to play a Blockygame trivia quiz while waiting for a human agent. The user enters a response 302b1 indicating “Yes,” the user would like to play the Blockygame trivia quiz while waiting for the human agent to enter the chat interface.

In chatbox 302b2 of FIG. 3(b), a Blockygame trivia quiz is presented in the chat messaging interface. The trivia quiz is selected according to any of the LLM techniques discussed in detail above, including a best match selection implementation and a real-time single quiz generation implementation. In the particular example illustrated in the chatbox 302b2, a multiple-choice question is presented in the chat messaging interface related to what constitutes an exciting event in Blockygame. The multiple choice questions are exemplary only, and any of a variety of other types of quiz questions are also contemplated as a way of quizzing the user, e.g., true/false, fill in the blank, matching, and so on.

In the screenshot 302b, the user enters a response 302b3 into the chat messaging interface to the trivia question about an exciting event in Blockygame. In particular, the user enters the response 302b3 that encountering an Orange Pig is an exciting event in Blockygame. The user could have also entered into the chat messaging interface any of the letters “A”, “B”, “C”, or “D” as a response to the multiple-choice question of the quiz in the chatbox 302b2.

FIG. 3(c) depicts a screenshot 302c of a chat messaging interface provided in the in the display of a mobile device where a chat with a virtual chat assistant of the online marketplace 112 continues. The screenshot 302c illustrates a chatbox 302c1 that is presented in the chat messaging interface after the user has provided the response 302b3 (Orange Pig) to the trivia quiz presented in chatbox 302b2. In particular, the chatbox 302c1 illustrates a plurality of listings 118 from the online marketplace 112 that will be of interest to the user based on the user selection of Orange Pig in the response 302b3 to the trivia quiz. The listings 118 presented in chatbox 302c1 may be different toys and/or items related to the Orange Pig found in Blockygame.

The user enters a response 302c2 into the chat messaging interface indicating that the user is interested in learning more about the listing titled “Plastic Squares Blockygame Baby Orange Pig *RARE*.” In chatbox 302c3, the virtual assistant in the chat messaging interface of the application 110 further provides a confirmation that information is being emailed to the user about the specific listing, “Plastic Squares Blockygame Baby Orange Pig *RARE*.”

In FIG. 3(c) when the user enters the response 302c2 in the chat messaging interface indicating an interest in the “Plastic Squares Blockygame Baby Orange Pig RARE*,” the application 110 can further store this selection in the user information 228, and the selection is further provided to the user information repository 128. The selection may become part of the user's shopping history or watch-list history in the user information repository 128 such that trends in the user's knowledge or interests are identified and analyzed. The selection may also be used to update general information on the particular listing 118 stored in the storage device 114 regarding overall interests and trends in the particular item “Plastic Squares Blockygame Baby Orange Pig RARE. *” Alternatively, or additionally, the service provider system 104 uses this information to update at least a portion of the information associated with the online marketplace 112, such as based on the identified trends in user knowledge or interests. As used herein, the term “user knowledge” refers to information, insights, or familiarity that are demonstrated or determined to be possessed (e.g., based on answering quiz questions, tracking user navigations, and/or sessions initiated with customer service) by a user of a particular online marketplace, such as the online marketplace 112, regarding the platform's features, navigation, policies, frequently asked questions (FAQs), and/or best practices for activities like searching, buying, or selling items. This knowledge may be acquired through prior experience, training, and/or exposure to the platform's interface and functionality.

FIG. 3(d) depicts a screenshot 302d of a chat messaging interface provided in the in the display of a mobile device where a chat with a virtual chat assistant of the online marketplace 112 continues. In the screenshot 302d, the virtual chat assistant presents a chatbox 302d1 with a hyperlink to the listing 118 of “Plastic Squares Blockygame Baby Orange Pig *RARE*.” The hyperlink presents a small photograph from the listing 118. In the mobile device on which the screenshot 302d appears, the user simply taps the hyperlink in the chatbox 302d1 to have a browser open with the webpage of the listing 118 of the “Plastic Squares Blockygame Baby Orange Pig *RARE*.”

Approximately contemporaneous to the presentation of the hyperlink to the listing 118 of the “Plastic Squares Blockygame Baby Orange Pig *RARE*” in the chat messaging interface at chatbox 302d1 in the application 110, the virtual chat assistant in the chat messaging interface indicates that a human agent is available to chat with the user. Specifically, in chatbox 302d2, the virtual assistant informs the user that a live (e.g., human) agent “Joseph” is available for chat.

The virtual assistant further inquires whether the user would prefer to end the trivia quiz interaction presented in the chat messaging interface, and be transferred so as to chat with the human agent Joesph, or whether the user would prefer to continue to play the trivia quiz. In response 302d3, the user indicates that the user would like to “Transfer” to chat with the human agent.

FIG. 3(e) depicts a screenshot 302e of a chat messaging interface provided in the in the display of a mobile device where a chat with a live human agent of the online marketplace 112 occurs. In the screenshot 302e, the chat messaging interface indicates at chatbox 302e1 that the live agent “Joesph” has joined the chat messaging space. At the chatbox 302e2, the live agent “Joseph” inquires as to how he can assist the user who has just interfaced with an LLM-based personalized chat quiz, such as quiz 230 in FIG. 2, in the chat messaging interface in the application 110 of the computing device 102.

The exact statements in the chat messaging interface and the exact chat quiz questions and answers presented in the discussion of FIG. 3(a) to 3(e) are exemplary only. There can be many different quizzes presented in the chat messaging interface as discussed in detail above with reference to FIG. 2. Other variations from the above exemplary chat messaging interface may occur such as the user agreeing to answer additional quizzes. As well, a user may decide not to obtain more information about a particular listing 118 that is presented in the chat messaging interface related to a quiz answer.

### Example Procedures

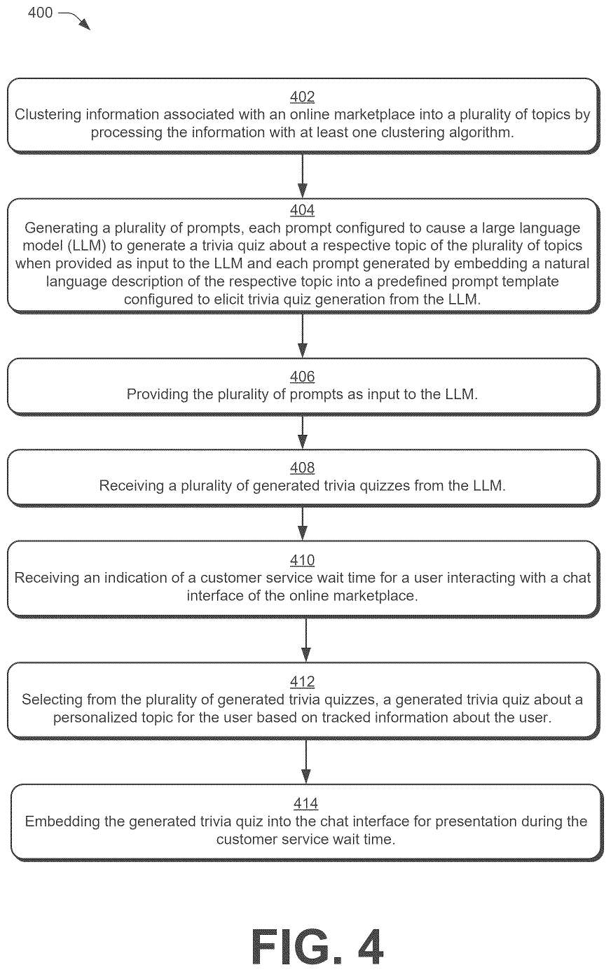

FIG. 4 depicts a procedure 400 in an example implementation of an LLM-based personalized chat quiz generation.

Information associated with an online marketplace is clustered into a plurality of topics by processing the information with at least one clustering algorithm (block 402). By way of example, the LLM-based quiz generator 122 clusters information associated with the online marketplace 112, such as by clustering at least portions of the real-time listing data 116, the internal documents 124, and/or information from the user repository 128, into a plurality of clusters corresponding to topics. In one or more implementations, the at least one computing device 102 clusters the information by processing it with at least one clustering algorithm, examples of which include but are not limited to k-means, k-medoids, k-medians, Clustering Large Applications based on RANdomized Search (CLARANS), and balanced iterative reducing and clustering using hierarchies (BIRCH), to name just a few.

A plurality of prompts is generated, each prompt being configured to cause a large language model (LLM) to generate a trivia quiz about a respective topic of the plurality of topics when provided as input to the LLM (block 404). Each prompt is generated by embedding a natural language description of the respective topic into a predefined prompt template configured to elicit trivia quiz generation from the LLM (block 404). By way of example, the similarity-based quiz picker 106 processes the clustered topics 212 so as to provides one or more of the topics in the prompts 222. The similarity-based quiz picker 106 uses a pre-defined prompt template to obtain each prompt 222 in nature language format. The natural language format of each prompt 222, when so applied, causes the LLM-based quiz generator 122, and specifically the quiz generator 216, to function and generate quizzes 220.

The plurality of prompts is provided as input to the LLM (block 406). By way of example, the similarity-based quiz picker 106 provides the prompts 222 (in natural language format) to the LLM-based quiz generator 122.

A plurality of generated trivia quizzes are received from the LLM (block 408). By way of example, the similarity-based quiz picker 106 receives from the LLM-based quiz generator 122 the plurality of quizzes 232. The quizzes 232 (selected from among the total generated quizzes 220) have been provided to the similarity-based quiz picker 106 based on topics that reflect user interest, such as purchase history, shopping cart contents, and watch list.

An indication of a customer service wait time for a user interacting with a chat interface of the online marketplace is received (block 410). By way of example, the similarity-based quiz picker 106 receives from the computing device 102 a wait time 236. The wait time 236 is determined by the computing device 102 to be the amount of time a user in a chat interface has to wait for customer service from the online marketplace 112.

A generated trivia quiz about a personalized topic for the user, based on tracked information about the user, is selected (block 412). By way of example, the quizzes 232 are converted into vectors 226 and the user information 228 (purchase history, watch list, shopping cart) is also converted into a vector 234. A vector comparison algorithm (such as cosine similarity or regression modeling) then selects from the plurality of quizzes 232 a personalized quiz 230 that best matches the user information 228.

The generated trivia quiz is embedded into the chat interface for presentation during the customer service wait time (block 414). By way of example, the personalized quiz 230 is provided to the computing device 102. The application 110 embeds the personalized quiz 230 into a chat messaging interface displayed during a wait time for a human customer service agent.

Having described examples of procedures in accordance with one or more implementations, consider now an example of a system and device that can be utilized to implement the various techniques described herein.

### Example System and Device

FIG. 5 illustrates an example of a system 500 that generally includes an example of a computing device 502 that is representative of one or more computing systems and/or devices that may implement the various techniques described herein. This is illustrated through the inclusion of the application 110 and the similarity-based quiz picker 106 as part of the computing device 102. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application-specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random-access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to the computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

Examples of the described techniques include one or more of the following and/or combinations of any one or more of the following.

In some aspects, the techniques described herein relate to a method, including: clustering, by at least one computing device, information associated with an online marketplace into a plurality of topics by processing the information with at least one clustering algorithm; generating, by the at least one computing device, a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM; providing, by the at least one computing device, the plurality of prompts as input to the LLM; receiving, by the at least one computing device, a plurality of generated trivia quizzes from the LLM; receiving, by the at least one computing device, an indication of a customer service wait time for a user interacting with a chat interface of the online marketplace; selecting, by the at least one computing device and from the plurality of generated trivia quizzes, a generated trivia quiz about a personalized topic for the user based on tracked information about the user; and embedding, by the at least one computing device, the generated trivia quiz into the chat interface for presentation during the customer service wait time.

In some aspects, the techniques described herein relate to a method, wherein the tracked information about the user includes at least one of purchase history, watch list items, or shopping cart contents associated with the user.

In some aspects, the techniques described herein relate to a method, further including fine-tuning the LLM using a corpus of the information associated with the online marketplace prior to providing the plurality of prompts as input.

In some aspects, the techniques described herein relate to a method, wherein fine-tuning the LLM includes training the LLM using at least one of a masked-token training technique or a next-token training technique on sentences derived from a knowledge base associated with the online marketplace.

In some aspects, the techniques described herein relate to a method, wherein the information associated with the online marketplace includes at least one of listing data of items listed on the online marketplace, frequently asked questions curated for the online marketplace, articles from a customer service repository associated with the online marketplace, or press releases published by the online marketplace.

In some aspects, the techniques described herein relate to a method, further including: storing user responses to the plurality of generated trivia quizzes; and analyzing the stored user responses to identify trends in user knowledge or interests.

In some aspects, the techniques described herein relate to a method, further including updating at least a portion of the information associated with the online marketplace based on the identified trends in user knowledge or interests.

In some aspects, the techniques described herein relate to a method, wherein selecting the generated trivia quiz about the personalized topic for the user is based on a similarity between vectors representing the tracked information about the user and the generated trivia quiz about the personalized topic.

In some aspects, the techniques described herein relate to a computing device including: a processing device; and a non-transitory computer-readable storage medium storing instructions that, responsive to execution by the processing device, cause the processing device to perform operations including: clustering information associated with an online marketplace into a plurality of topics by processing the information with at least one clustering algorithm; generating a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM; providing the plurality of prompts as input to the LLM; receiving a plurality of generated trivia quizzes from the LLM; receiving an indication of a customer service wait time for a user interacting with a chat interface of the online marketplace; selecting from the plurality of generated trivia quizzes, a generated trivia quiz about a personalized topic for the user based on tracked information about the user; and embedding the generated trivia quiz into the chat interface for presentation during the customer service wait time.

In some aspects, the techniques described herein relate to a computing device, wherein the tracked information about the user includes at least one of purchase history, watch list items, or shopping cart contents associated with the user.

In some aspects, the techniques described herein relate to a computing device, wherein the operations further include fine-tuning the LLM using a corpus of the information associated with the online marketplace prior to providing the plurality of prompts as input.

In some aspects, the techniques described herein relate to a computing device, wherein the information associated with the online marketplace includes at least one of listing data of items listed on the online marketplace, frequently asked questions curated for the online marketplace, articles from a customer service repository associated with the online marketplace, or press releases published by the online marketplace.

In some aspects, the techniques described herein relate to a computing device, wherein the operations further include: storing user responses to the plurality of generated trivia quizzes; and analyzing the stored user responses to identify trends in user knowledge or interests.

In some aspects, the techniques described herein relate to a computing device, wherein selecting the generated trivia quiz about the personalized topic for the user is based on a similarity between vectors representing the tracked information about the user and the generated trivia quiz about the personalized topic.

In some aspects, the techniques described herein relate to a non-transitory computer-readable storage medium having instructions stored thereon, that responsive to execution by a processor of a computing device, cause the processor to perform operations including: clustering information associated with an online marketplace into a plurality of topics by processing the information with at least one clustering algorithm; generating a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM; providing the plurality of prompts as input to the LLM; receiving a plurality of generated trivia quizzes from the LLM; receiving an indication of a customer service wait time for a user interacting with a chat interface of the online marketplace; selecting from the plurality of generated trivia quizzes, a generated trivia quiz about a personalized topic for the user based on tracked information about the user; and embedding the generated trivia quiz into the chat interface for presentation during the customer service wait time.

In some aspects, the techniques described herein relate to a non-transitory computer-readable storage medium, wherein the tracked information about the user includes at least one of purchase history, watch list items, or shopping cart contents associated with the user.

In some aspects, the techniques described herein relate to a non-transitory computer-readable storage medium, wherein the operations further include fine-tuning the LLM using a corpus of the information associated with the online marketplace prior to providing the plurality of prompts as input.

In some aspects, the techniques described herein relate to a non-transitory computer-readable storage medium, wherein the information associated with the online marketplace includes at least one of listing data of items listed on the online marketplace, frequently asked questions curated for the online marketplace, articles from a customer service repository associated with the online marketplace, or press releases published by the online marketplace.

In some aspects, the techniques described herein relate to a non-transitory computer-readable storage medium, wherein the operations further include: storing user responses to the plurality of generated trivia quizzes; and analyzing the stored user responses to identify trends in user knowledge or interests.

In some aspects, the techniques described herein relate to a non-transitory computer-readable storage medium, wherein selecting the generated trivia quiz about the personalized topic for the user is based on a similarity between vectors representing the tracked information about the user and the generated trivia quiz about the personalized topic.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method, comprising:
clustering, by at least one computing device, information associated with an online marketplace into a plurality of topics by processing the information with at least one clustering algorithm;
generating, by the at least one computing device, a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM;
providing, by the at least one computing device, the plurality of prompts as input to the LLM;
receiving, by the at least one computing device, a plurality of generated trivia quizzes from the LLM;
receiving, by the at least one computing device, an indication of a customer service wait time for a user interacting with a chat interface of the online marketplace;
selecting, by the at least one computing device and from the plurality of generated trivia quizzes, a generated trivia quiz about a personalized topic for the user based on tracked information about the user; and
embedding, by the at least one computing device, the generated trivia quiz into the chat interface for presentation during the customer service wait time.

2. The method of claim 1, wherein the tracked information about the user includes at least one of purchase history, watch list items, or shopping cart contents associated with the user.

3. The method of claim 1, further comprising fine-tuning the LLM using a corpus of the information associated with the online marketplace prior to providing the plurality of prompts as input.

4. The method of claim 3, wherein fine-tuning the LLM includes training the LLM using at least one of a masked-token training technique or a next-token training technique on sentences derived from a knowledge base associated with the online marketplace.

5. The method of claim 1, wherein the information associated with the online marketplace includes at least one of listing data of items listed on the online marketplace, frequently asked questions curated for the online marketplace, articles from a customer service repository associated with the online marketplace, or press releases published by the online marketplace.

6. The method of claim 1, further comprising:
storing user responses to the plurality of generated trivia quizzes; and
analyzing the stored user responses to identify trends in user knowledge or interests.

7. The method of claim 6, further comprising updating at least a portion of the information associated with the online marketplace based on the identified trends in user knowledge or interests.

8. The method of claim 1, wherein selecting the generated trivia quiz about the personalized topic for the user is based on a similarity between vectors representing the tracked information about the user and the generated trivia quiz about the personalized topic.

9. A computing device comprising:
a processing device; and
a non-transitory computer-readable storage medium storing instructions that, responsive to execution by the processing device, cause the processing device to perform operations including:
clustering information associated with an online marketplace into a plurality of topics by processing the information with at least one clustering algorithm;
generating a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM;
providing the plurality of prompts as input to the LLM;
receiving a plurality of generated trivia quizzes from the LLM;
receiving an indication of a customer service wait time for a user interacting with a chat interface of the online marketplace;
selecting from the plurality of generated trivia quizzes, a generated trivia quiz about a personalized topic for the user based on tracked information about the user; and
embedding the generated trivia quiz into the chat interface for presentation during the customer service wait time.

10. The computing device of claim 9, wherein the tracked information about the user includes at least one of purchase history, watch list items, or shopping cart contents associated with the user.

11. The computing device of claim 9, wherein the operations further include fine-tuning the LLM using a corpus of the information associated with the online marketplace prior to providing the plurality of prompts as input.

12. The computing device of claim 9, wherein the information associated with the online marketplace includes at least one of listing data of items listed on the online marketplace, frequently asked questions curated for the online marketplace, articles from a customer service repository associated with the online marketplace, or press releases published by the online marketplace.

13. The computing device of claim 9, wherein the operations further include:
storing user responses to the plurality of generated trivia quizzes; and
analyzing the stored user responses to identify trends in user knowledge or interests.

14. The computing device of claim 9, wherein selecting the generated trivia quiz about the personalized topic for the user is based on a similarity between vectors representing the tracked information about the user and the generated trivia quiz about the personalized topic.

15. A non-transitory computer-readable storage medium having instructions stored thereon, that responsive to execution by a processor of a computing device, cause the processor to perform operations including:
clustering information associated with an online marketplace into a plurality of topics by processing the information with at least one clustering algorithm;
generating a plurality of prompts, each prompt configured to cause a large language model (LLM) to generate a trivia quiz about a respective topic of the plurality of topics when provided as input to the LLM and each prompt generated by embedding a natural language description of the respective topic into a predefined prompt template configured to elicit trivia quiz generation from the LLM;
providing the plurality of prompts as input to the LLM;
receiving a plurality of generated trivia quizzes from the LLM;
receiving an indication of a customer service wait time for a user interacting with a chat interface of the online marketplace;
selecting from the plurality of generated trivia quizzes, a generated trivia quiz about a personalized topic for the user based on tracked information about the user; and
embedding the generated trivia quiz into the chat interface for presentation during the customer service wait time.

16. The non-transitory computer-readable storage medium of claim 15, wherein the tracked information about the user includes at least one of purchase history, watch list items, or shopping cart contents associated with the user.

17. The non-transitory computer-readable storage medium of claim 15, wherein the operations further include fine-tuning the LLM using a corpus of the information associated with the online marketplace prior to providing the plurality of prompts as input.

18. The non-transitory computer-readable storage medium of claim 15, wherein the information associated with the online marketplace includes at least one of listing data of items listed on the online marketplace, frequently asked questions curated for the online marketplace, articles from a customer service repository associated with the online marketplace, or press releases published by the online marketplace.

19. The non-transitory computer-readable storage medium of claim 15, wherein the operations further include:
storing user responses to the plurality of generated trivia quizzes; and
analyzing the stored user responses to identify trends in user knowledge or interests.

20. The non-transitory computer-readable storage medium of claim 15, wherein selecting the generated trivia quiz about the personalized topic for the user is based on a similarity between vectors representing the tracked information about the user and the generated trivia quiz about the personalized topic.
